(19) United States
(12) Patent Application Publication
(10) Pub. No.: US 2014/0319065 A1
(43) Pub. Date: Oct. 30, 2014

(54) AUGMENTED POLYACRYLATE ANTI-SCALE MEDIA AND METHODS OF MAKING THE SAME

(71) Applicant: KX Technologies LLC, West Haven, CT (US)

(72) Inventors: Bruce Taylor, Cheshire, CT (US); Frank A. Brigano, Northford, CT (US); George Dimotsis, Woodbury, MN (US)

(73) Assignee: KX Technologies LLC, West Haven, CT (US)

(21) Appl. No.: 14/258,508

(22) Filed: Apr. 22, 2014

Related U.S. Application Data
(60) Provisional application No. 61/815,829, filed on Apr. 25, 2013.

(51) Int. Cl. C02F 5/10; C02F 1/42

(52) U.S. Cl. CPC C02F 5/10; C02F 1/42; C02F 2001/425
USPC 210/701; 252/176

(57) ABSTRACT

A scale suppression media and methods of making augmented polyacrylate resin beads combined with a directing agent to facilitate the formation of calcite and aragonite forms of calcium carbonate, the directing agent deposited directly into said polyacrylate resin beads. A strong acid monovalent salt, such as a metal ion, is added to the polyacrylate resin, and is adapted to be time released, and templates the calcium carbonate in the influent to form crystals in the water with reduced deposition of scale on the surfaces of material in contact with the water. The pores of the resin are filled with metal templating agent, and the agent is released as the influent passes over the resin.

### BACKGROUND OF THE INVENTION

1. Field of the Invention

The present invention relates to an anti-scaling media, and specifically, to an augmented polyacrylate anti-scale media. The polyacrylate anti-scale media promotes scale suppression through release of a polyacrylate polymer into the treated water, and the deposition of calcium carbonate inside the pore structure of the polyacrylate resin, which may be in bead or sheet form, and release of calcium or aluminum in the water as a templating mechanism.

2. Description of Related Art

Scaling or scale formation generally involves the precipitation and deposition of dense materials on surfaces made of metal and other materials. Scale obstructions are generated on heat exchange surfaces and inside pipes which are in contact with water in a water system, such as a cooling water system, a boiler water system, evaporators, reactors, filter cloths, reverse osmosis membrane surfaces, oil wells, desalination evaporators, or the like. The types of scales which are deposited include calcium carbonate, calcium sulfate, calcium sulfite, calcium phosphate, calcium silicate, calcium oxalate, barium sulfate, magnesium silicate, magnesium hydroxide, zinc phosphate, zinc hydroxide, basic zinc carbonate, and the like. Scale formation may occur when these inorganic mineral salts precipitate from liquids and deposit on the inside surfaces of a system.

Scale formation may cause a number of operational problems, including but not limited to, plugging of equipment, pressure loss, increased utility costs, reduced heat exchange capacity, corrosion, lost production due to downtime, and downgraded products due to insufficient feeds.

Scaling has been shown to be reduced by placing in contact with the water a material which will release ions and minute particles of oxides or hydroxides which remain in suspension in the water and form sites for crystallization or coagulation of scale-forming impurities in the water. This has been previously attained by electrolytic action utilizing the sacrificial material as an anode in combination with a cathode connected in electrical circuit with the anode, the anode and cathode being arranged such that the water passes between them and acts as an electrolyte.

Hard water may be treated to counter the deposition of scale by releasing into the water ions and salts of a selected metal, by introducing into the water a component comprising the selected metal and a more noble metal in contact with one another, whereby to induce the release from the selected metal of ions and salt particles operative to induce coagulation and crystallization of scale forming impurities in suspension in the water. The presence of electric fields affects the formation of crystals and precipitates and their subsequent behavior.

In U.S. Patent Publication No. 2012/0211419 to Koslow, published on Aug. 23, 2012, a method of producing a scale-control resin is taught which includes combining in an aqueous solution a cation-exchange resin and a weak-acid mineral or salt having multivalent cation to allow ion exchange between the resin and the multivalent cation. The application does not teach a strong acid salt for neutralization or a polyvalent strong acid salt, such as calcium chloride, to convert the resin by ion exchange. Koslow teaches the use of weak acid anion (weak acid salt) such as carbonate to form the conversion. In contrast, the present invention utilizes a strong base and a strong acid salt in a two-step process, converting to the sodium form first.

Polymers which contain carboxyl groups, such as polymerized maleic acid, acrylic acid, itaconic acid, and the like are often effective in inhibiting formation of calcium or magnesium scale. Furthermore, copolymers which combine monomers with a carboxyl group and monomers which contain a sulfonic acid group, such as vinyl sulfonic acid, allyl sulfonic acid, and 2-acrylamide-2-methylpropane sulfonic acid, are often used as scale preventing agents, depending on the water quality. To inhibit formation of silica scale, scale preventing agents such as acrylamide polymers, cation polymers, polyethylene glycol, and the like, have been proposed. Thus, different polymers have been used to inhibit scale formation, depending on the type of scale.

### SUMMARY OF THE INVENTION

Bearing in mind the problems and deficiencies of the prior art, it is therefore an object of the present invention to provide a novel media for suppressing the formation of scale in fluid systems, and a method of making the media.

It is another object of the present invention to provide a scale suppressing media that facilitates forming calcium carbonate in a similar manner as aragonite such that the calcium carbonate or aragonite flakes off easily in the fluid system.

Still other objects and advantages of the invention will in part be obvious and will in part be apparent from the specification.

The above and other objects, which will be apparent to those skilled in the art, are achieved in the present invention in a first aspect which is directed to a scale suppression media comprising polyacrylate resin beads combined with a monovalent strong acid salt directing agent to facilitate the formation of calcite and aragonite forms of calcium carbonate, the directing agent deposited directly into the polyacrylate resin beads. The scale suppression including a monovalent strong acid salt for the directing agent, where the monovalent strong acid salt may include aluminum sulfate or zinc nitrate.

In a second aspect, the present invention is directed to a method of preventing the formation of scale in fluid systems comprising: augmenting polyacrylate resin to release the polymer from the resin beads into the fluid, precipitate calcium carbonate in pore structures of the polyacrylate resin beads, and template calcium ions into calcite or aragonite by doping the polyacrylate resin beads with calcium carbonate, and in other embodiments aluminum or zinc or other materials as templating agents. The method may include dissolving the resin into the fluid and coating the calcium ions in the fluid. The method may further include forming seed crystals of calcite or aragonite by offering a template to steer calcium carbonate in solution.

In a third aspect, the present invention is directed to a method of producing a scale-control resin media comprising: stabilizing the resin; forming scale within the media to maximize the potential of condensing scale in the media's pore structure; and generating scale templating agents.

The step of stabilizing the resin may include: neutralizing the resin to be free of calcium; mixing the resin with sodium carbonate; heating the mixture to approximately 80° C. for about four hours while stirring the mixture periodically; rinsing the mixture with deionized water; and drying the mixture at approximately 100° C. for about eight hours.

The step of stabilizing the resin may further include: loading the resin with calcium without carbonate present; mixing the resin with sodium carbonate; heating the mixture to approximately 80° C. for about four hours while stirring the mixture periodically; rinsing the mixture with deionized water; combining the resin mixture with a solution of calcium chloride in deionized water; heat the combination to approximately 80° C. while stirring the combination periodically; and wash the heated combination with deionized water.

The step of forming scale within the media to maximize the potential of condensing scale in the media's pore structure may include: neutralizing acidity of the media by combining the resin with deionized water; mixing the combined resin and water with sodium carbonate and calcium carbonate; heating the mixture to approximately 80° C. while stirring periodically for about eight hours; rinsing to remove excess calcium carbonate; and drying the mixture at about 100° C. for approximately eight (8) hours.

The step of generating scale templating agents includes loading the resin with calcium carbonate and a calcite directing agent or an aragonite directing agent. The calcite directing agent may include aluminum sulfate. The aragonite directing agent may include zinc nitrate or zinc chloride.

The method may further include: mixing the resin with deionized water and adding aluminum sulfate; heating the mixture at approximately 80° C. while stirring periodically for about four hours; rinsing the heated mixture with deionized water and adding fresh deionized water; adding calcium carbonate and calcium chloride; heating the resultant mixture to about 80° C. with periodic stirring for about eight hours; rinsing off excess carbonate with deionized water; and drying the resultant product at about 100° C. for approximately eight hours.

In addition, the method may include: mixing the resin with deionized water; dissolving the mixed resin in zinc nitrate or zinc chloride; adding calcium carbonate and calcium chloride to the mixture; heating the resultant mixture to approximately 80° C. with periodic stirring for about eight hours; rinsing off excess carbonate with deionized water; and drying the resultant product at about 100° C. for approximately eight hours.

In a fourth aspect, the present invention is directed to a method of producing a scale-control resin media comprising: treating a hydrogen form WAC resin by first neutralizing the resin with stoichiometric amounts of NaOH and passing it through the WAC resin in a column configuration to generate an Na form of the resin; converting the Na form resin to a Ca form resin by passing an aqueous calcium solution through the Na form resin; rinsing the aqueous calcium solution from the resin with deionized water; and isolating the resin by dewatering through a filter.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a table comprising the results of the calcium reduction rates of augmented polyacrylate media for five samples.

FIG. 2 depicts an SEM image demonstrating salient features of the above-identified test sets; and

FIG. 3 depicts a graph of scale reduction versus contact time normalized to bed volume for treated WAC resins.

### DESCRIPTION OF THE PREFERRED EMBODIMENT(S)

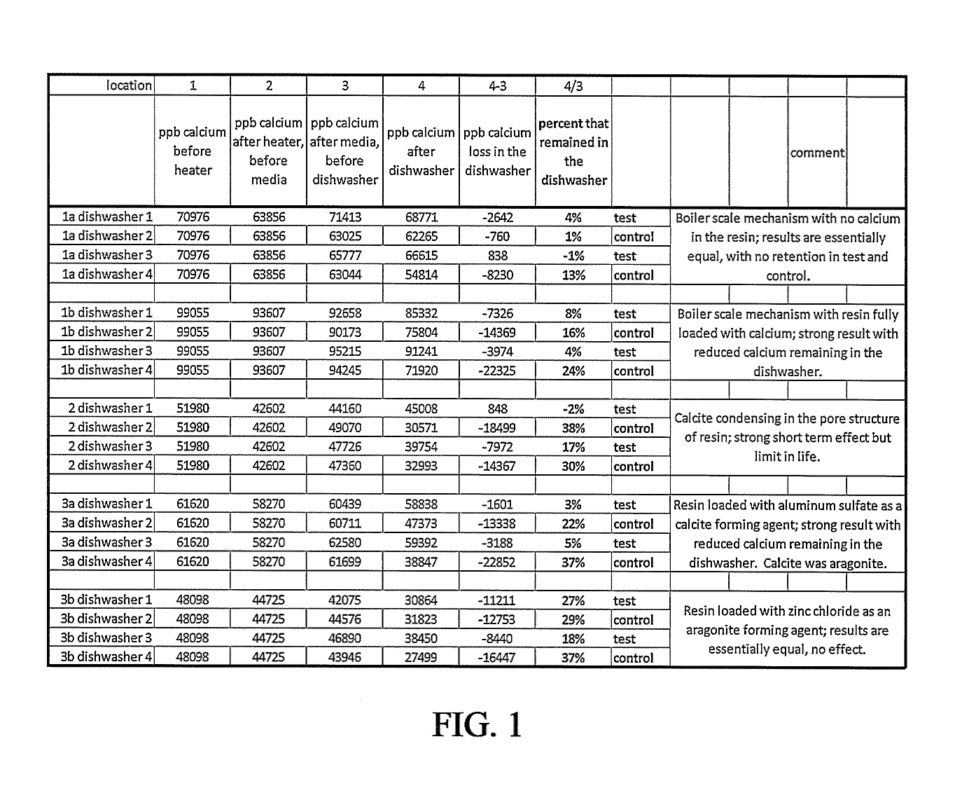

In describing the preferred embodiment of the present invention, reference will be made herein to FIGS. 1-3 of the drawings in which like numerals refer to like features of the invention.

An augmented polyacrylate anti-scale media is proposed to suppress scaling through release of polyacrylate polymer into water and to deposit calcium carbonate inside the pore structure of the polyacrylate resin, and to template by release the calcium ions and in other embodiments aluminum and zinc as templating agents, which resin may be in bead or sheet form. Caution is taken with respect to the typical acid form of the polyacrylate resin, insomuch as a non-augmented media is a classic cation exchanger and will initially acidify the water around itself as calcium, magnesium, and sodium, displacing the initial hydrogen ions. This non-augmented media will dissolve some scale, but the desired effect will be extremely short lived. Thus, the resin must be stabilized so that it does not cover itself with scale.

In the preferred embodiment, a monovalent strong acid salt neutralizes the resin, and a polyvalent strong acid salt converts the resin by ion exchange. The augmented polyacrylate resin is adapted to be time released, and templates the calcium carbonate in the influent to form crystals in the water with reduced deposition of scale on the surfaces of material in contact with the water. The pores of the resin are filled with metal templating agent, and the agent is released as the influent passes over the resin.

The present invention presents a novel mechanism for scale suppression that is effectively built into the polyacrylate resin beads. The addition of aluminum sulfate or zinc nitrate or other strong acid salts into polyacrylate scale reduction media performs as a directing agent for the formation of calcite and aragonite forms of calcium carbonate. The calcite and aragonite seeds do not collect on the interior of the heating system components as easily and are shed with the effluent from the process or system. Success of anti-scaling has been shown in systems with hot influent as well as cold influent, in such systems as dishwashers and hot water heaters.

For testing purposes, the augmentation process was performed on a polyacrylate media from Dow Corporation. The present invention is not directed solely to this specific polyacrylate media from Dow Corporation, and other types of polyacrylate media may be used.

The original media was initially designed for pretreatment membranes to prevent scaling. With modification (augmentation), the media has been shown to have a positive anti-scale effect on hard water. Five tests were performed to identify the functional mechanism of the anti-scale ability. Three functional mechanisms have been identified: 1) release of polyacrylate into the water such as in a boiler water application; 2) accumulation of calcite in the pore structure of the polyacrylate resin beads; and 3) templating the calcium ions into calcite and aragonite.

The first two mechanisms are innate to the polyacrylate resin beads. The templating of calcium carbonate into aragonite was developed and enhanced by doping the polyacrylate resin beads with calcium carbonate and in other embodiments the addition of aluminum or zinc as templating agents.

Initial testing considered the accumulation and release of calcium carbonate from dishwashers. The test was performed in four dishwashers. There were two treated dishwashers and two control dishwashers. In each dishwasher there were media sumps into which was placed a refillable cartridge with loose polyacrylate media. The sumps were plumbed so that the water flowed in reverse of the usual direction, compressing the resin into the refillable cartridge. The control circuitry of the dishwashers was modified so that the dishwashers would run continuous cycles without intervention. The dishwashers were cleaned before and after each set of tests to eliminate contamination from the previous testing.

The tests were performed at a location where the municipal water supply is consistent in presenting hard water to the customers. The water is typically 12 grains per gallon (gpg) to 16 gpg, where 1 grain per gallon equals 64.8 milligrams of calcium carbonate dissolved in 1 U.S. gallon of water (3.785 liters). This location was chosen to mirror ASTM standards, which dictate that the water should be as close to 20 gpg as possible and naturally hard water. The scale is of two primary types: aragonite soft scale and calcite hard scale. Both scales are compounds of calcium carbonate but the aragonite is nearly pure calcium carbonate, whereas the calcite is a mixture of calcium carbonate with about one quarter magnesium hydroxide with traces of other ions such as iron, manganese, and others. Aragonite is quickly identified microscopically by the long needlelike growths. The calcite can appear as an amorphous pile of material without a repeated shape. Importantly, these two types of scales are not interchangeable.

The dishwashers were plumbed in parallel with hot water heaters and test points. The dishwashers have a single source of hot water. Two 10 gallon hot water heaters were arranged in series for the test. The water was heated by the first hot water heater, and the second was used to maintain the temperature. This eliminated any concern of a fluctuation in water temperature as the tank was drained and refilled with ambient water. The heaters ensured that the water was consistently very close to 140° F. This temperature was chosen because it is on the high end of normal household water supply and because the high temperature will increase the rate of dissolution of the polyacrylate.

All of the hoses were arranged to the same length to and from each dishwasher to reduce any external effects on the test and to reduce variables. Water temperature, pressure and flow were recorded for each dishwasher.

Test points were arranged in the following locations: a) before the water heaters; b) after the water heaters; c) after the media sump for each dishwasher (i.e., the influent for the dishwasher); and d) after each dishwasher (i.e., the effluent for each dishwasher). The test points were numbered and these numbers were used for the ICPMS vials for the samples analyzed for characterization.

After each test, the dishwashers were cleansed with acetic acid and a commercially available calcium, lime, and rust remover, followed by repeated cycles to complete the removal process. Scanning electron microscope mounts were prepared and cycled in the dishwasher during the flush process with water from the cleaning process to ensure that there was no free calcite in the dishwasher to contaminate the next set of tests.

Test results were analyzed using Inductively Coupled Plasma Mass Spectrometer (ICPMS), Scanning Electron Microscope, and Gas Chromatographic Mass Spectroscope (GCMS). Total Organic Carbon (TOC), hardness, pH, and other tests were also performed. The ICPMS data for the calcium results were chiefly monitored, as the calcium carbonate makes up the majority of the scale buildup in the dishwashers and on the hot water heater elements.

Polyacrylate resin beads were prepared in five preparations. The preparations were designed to test functional mechanism individually with limited interference from the other potential mechanisms. The three primary anticipated functional mechanisms for polyacrylate resin beads for anti-scale ability are: a) dissolution of the resin into the water and coating of the calcium ions in the water, which is the mechanism in boiler-scale reduction; b) precipitation of the calcite into the pore structure of the polyacrylate resin beads, which acts as a softener; and c) offering a template to steer the calcium carbonate in solution to the formation of calcite or aragonite seeds before it can accumulate on the interior of the dishwasher or hot water heater element.

### The Preferred Resin Treatments

First, the resin is stabilized so as not to cover itself with scale. This maximized the potential dissolution of the resin. Stabilization was performed by two separate methods as delineated herein.

In one stabilization procedure (referred herein as Test Method 1a), the resin was neutralized until it was shown to be completely free of excess calcium. The neutralization process was performed by mixing the resin with a monovalent strong acid salt, sodium carbonate, heating the mixture to about 80° C. for approximately four (4) hours with consistent stirring, rinsing with deionized water, and dried at approximately 100° C. for about eight (8) hours.

In a second stabilization procedure (referred herein as Test Method 1b), the resin sample is completely loaded with calcium, but without carbonate present. The preparation steps for the first stabilization procedure are then repeated, but with a thorough washing step added to remove any excess sodium carbonate. In this alternative procedure, however, the sample is not dried. Rather, the resin sample is added to a solution of calcium chloride in deionized water, heated to 80° C. with stirring, washed with deionized (DI) water, and used as is (not dried).

Next, care was taken to maximize the potential of condensing scale in the media's pore structure by making a small amount of scale within the media, and neutralizing the acidity of the media (the method referred herein as Test Method 2). The resin is combined and mixed with DI water with sodium carbonate and calcium carbonate. It is then heated to approximately 80° C. with stirring for approximately eight (8) hours. The resultant product is then rinsed of excess calcium carbonate and dried at about 100° C. for approximately eight (8) hours or more.

To generate scale templating agents, the resin is then loaded with calcium carbonate and a calcite directing agent, such as aluminum, or aragonite directing agent (referred herein as Test Method 3a), such as zinc, although other directing agents may be employed, and the present invention is not limited to any single directing agent. The procedure used for generating scale templating agents by loading the resin with calcium carbonate and a calcite directing agent, including the following steps:
a) mixing the resin with DI water and adding aluminum sulfate;
b) heat the mixture while stirring at approximately 80° C. for about four (4) hours;
c) rinsing the heated mixture with DI water and adding fresh DI water;
d) adding calcium carbonate and calcium chloride;
e) heating the resultant mixture to about 80° C. with consistent stirring for about eight (8) hours;
f) rinsing off excess carbonate with DI water; and
g) drying the resultant product at about 100° C. for approximately eight (8) hours or more.

The procedure used for generating scale templating agents by loading the resin with calcium carbonate and an aragonite directing agent, including the following steps (referred herein as Test Method 3b):
a) mixing the resin with DI water;
b) dissolving the mixed resin in zinc nitrate (or chloride);
c) adding calcium carbonate and calcium chloride to this mixture;
d) heating the resultant mixture to approximately 80° C. with consistent stirring for about eight (8) hours;
e) rinsing off excess carbonate with DI water; and
f) drying the resultant product at about 100° C. for approximately eight (8) hours or more.

### Test Results

FIG. 1 depicts a table comprising the results of the calcium reduction rates of augmented polyacrylate media for five samples. The data depicts the ICPMS effluent samples at the end of each test. The results are displayed in the column labeled: “percent that remained in the dishwasher.” As indicated, the dishwashers treated with the augmented polyacrylate have lower retention of calcium than the untreated controls.

In Test Method 1a a boiler scale style is challenged, free of excess calcium, and loaded with carbonate. Superior shedding of calcium in the treated dishwashers is depicted.

In Test Method 1b a boiler scale style is challenged, loaded with calcium so it cannot condense within, and free of carbonate. Test results demonstrate that the released polyacrylate retarded the calcium from collecting in the dishwashers.

In Test Method 2 the calcium was condensed in the resin by seeding a small amount of calcium into the pore structure. Test results demonstrate a two-fold reduction of calcium in the treated dishwashers.

In the test samples for Test Method 3a, a calcite templating agent was generated using aluminum. Test results indicate a clear difference in the amount of calcium deposited in the dishwasher, demonstrating that the augmented polyacrylate anti-scaling attributes were successfully employed. SEM results revealed that only aragonite was formed on the glassware rather than the calcite. Thus, the Test 3a loading with aluminum resulted in templating of aragonite and clearly reduced accumulation of scale.

In Test Method 3b, an aragonite templating agent was generated using zinc. The test results indicated little significant difference in the amount of calcium retained in the dishwasher.

Overall, three anti-scaling mechanisms are employed by the present invention: boiler-scale style scale suppression is produced by the release of small amounts of the polyacrylate into the dishwasher water; calcium is condensed in the resin beads and is removed from the process; and templating of the calcium ions into solid crystals is directed by doping the polyacrylate resin beads with a templating agent.

One resultant difference between testing with a dishwasher and testing with a water heater is the effect of high temperature water. The high temperature of water for a Point-of-Use (POU) application promotes much of the scale forming before the dishwasher. Scale forms on the heating element as the temperature rises and the incoming water is raised to the operating temperature. In the exemplary tests, the temperature was raised to approximately 140° F. before the fluid came in contact with the polyacrylate resin. Consequently, in that instance, it is apparent that some of the scale had formed before contact with the polyacrylate resin was initiated; however, the test clearly demonstrates the successful formation of aragonite and successful reduction of scale buildup in the treated dishwashers. It is evident the augmented polyacrylate anti-scaling media could be effectively used as POU for dishwashers.

Point of Entry (POE) systems in the field will have an increasing water temperature after the polyacrylate resin has been introduced into the influent water stream and the antiscale effect may be superior to the test described above as the polyacrylate is in the water when it hits the hot water heater element where the scale is frequently formed.

As is demonstrated, the ICPMS data is consistent across all data sets for reduction but it is not as wholly accurate in reporting the amount of calcium and other elements sampled, insomuch as the liquid standard that is used to generate a curve for each period of operation does not accommodate parts per million (ppm) of the calcium and magnesium because it is sensitive to parts per billion (ppb) challenges. Thus, the calcium influent levels vary for each set of tests and do not mathematically correlate to the 16 grains per gallon that was shown consistently to be in the challenge water. However, although the numerical values are not deemed accurate, the proportional changes in any particular set of tests, i.e., test results for Tests “1b” and “3a” are precise, and are reliably accurate.

The tested fluid samples from the dishwashers were then processed through the ICPMS, and were compared to expected results, extrapolated to the levels presented. With no effect, the retention is null, and if there is reduction, the proportion is revealed. This issue was resolved for a second batch of tests with the acquisition of a set of calibrated fluid standards that covered the ppm levels presented in the test.

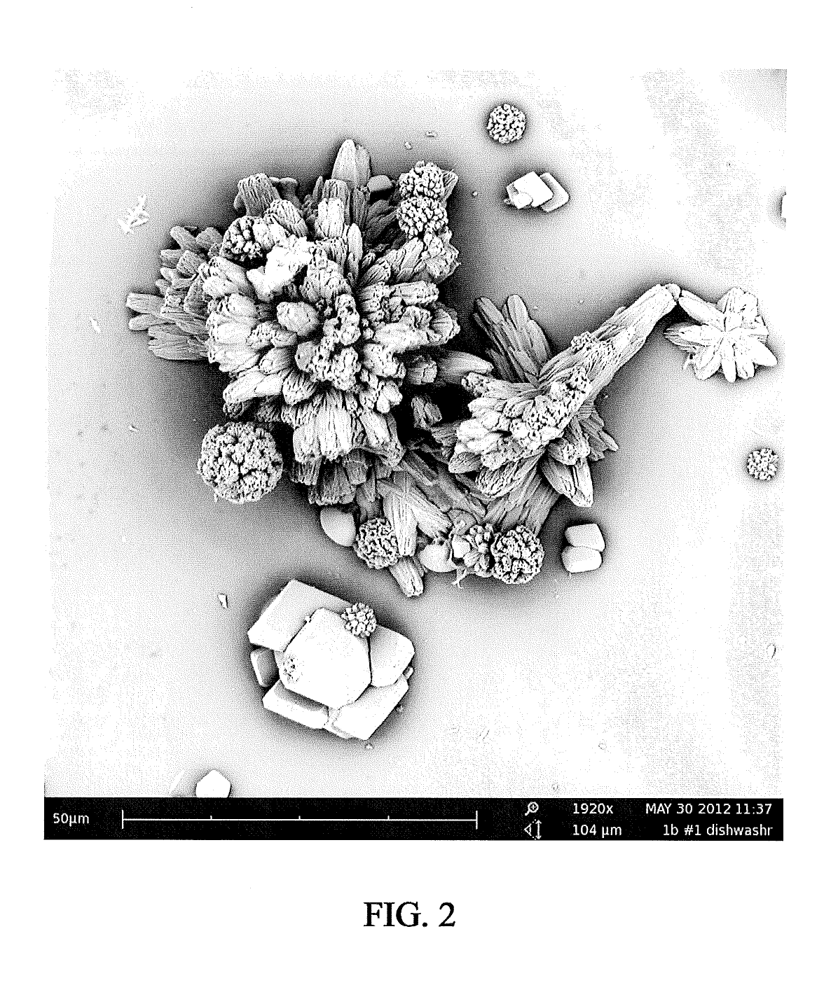

FIG. 2 depicts an SEM image demonstrating salient features of the above-identified test sets. Scanning electron micrographs were taken of mounts from each test. The scanning electron microscope mounts had small glass plates adhered to them and were installed in the dishwashers for the duration of each battery of tests in both the control and treated dishwashers. The glass was exposed in order to see the type of material that was being generated and to get a rough quantification of the depositions.

The star shaped growths depicted in FIG. 2 are aragonite. The smooth accumulations are calcite. The aragonite forms regularly and with spikes. The spikes are worn down from agitation in the dishwasher. Note that there are multiple generations of scale growing on the SEM mount reflecting the number of drying cycles it was exposed to. There are also small aragonite and calcite crystals growing on main aragonite deposition.

The data derived from the SEM mounts indicate that the polyacrylate changed the morphology of the calcium carbonate to aragonite. The formation of aragonite was common in both the treated and the control dishwashers, and the formation of calcite was rare. The formation of scale on the control samples, and the larger size of the crystals are directly presented in results from the SEM and mirror the results from the ICPMS.

The augmented polyacrylate has been demonstrated to achieve three methods of scale reduction: 1) boiler scale reduction when fully loaded with calcium (refer: Tests “1a” and “1b”); 2) condensation of calcium carbonate on the interior of the resin (refer: Test “2”); and 3) generation of aragonite with the assistance of aluminum as a directing agent.

The boiler scale type of scale reduction (Test “1b”) and the generation of calcite (Test “3b”) are preferred methods of reduction. The condensation of scale (2) inside the pore structure of the resin is impressive, but the total surface area available inside the resin would not be adequate to support a long-term reduction of scale in a point-of-use system. The release of resin in a boiler-scale regimen with the additional benefit of the calcite steering mechanism produces a resin capable of inhibiting scale accumulation in point of use applications.

Test Method 1b was performed to the methodology of a DVGW test protocol. DVGW identifies Deutscher Verein des Gas- and Wasserfaches e.V.—Technisch-wissenschaftlicher Verein, which is the DVGW German Technical and Scientific Association for Gas and Water. Performance was measured using calcium from a weak acid cation (WAC) resin. WAC and weak base anion (WBA) resins are able to neutralize strong bases and acids, respectively. These resins are used for dealkalization, partial demineralization, or (in combination with strong resins) full demineralization. Materials were received as hydrogen form resins and converted to calcium form resins in the laboratory. Conversion was first by neutralization to sodium form and then conversion to calcium form with calcium chloride, since direct conversion of the acid form with CaCl₂ although possible, was deemed not as efficient.

Hydrogen form WAC resins, Lanxess® and Purolite®, were treated in the following manner:

a) the resins were neutralized with stoichiometric amounts of NaOH using a 5% aqueous NaOH and passing it through the WAC resin in a column configuration to generate the Na form of the resins;

b) the resins were then converted from the Na form to the Ca form by passing 100% stoichiometric Ca through the Na form resin as a 10% aqueous solution;

c) the aqueous calcium solution was rinsed from the resins with DI water; and

d) the resins were isolated by dewatering through a filter.

Testing of these treated Lanxess® and Purolite® resins was performed to closely approximate the DVGW testing. The test cycle was performed as follows:

1) fill test chamber having a 2.6 gallon volume for two (2) minutes, starting the overall cycle timer;

2) turning a heater “ON” at a low set temperature point of 125° F. by utilizing a thermocouple located approximately ⅓ up from the bottom of the chamber;

3) after heater activation, continue to fill chamber until 1.0 gallons has been introduced, as measured by time and flow rate;

4) continue heating until temperature reaches 140° F.;

5) maintain chamber in a dwell state (no further heating or filling) until approximately a twenty-eight (28) minute timer times out; at which point the cycle returns to step (1) above;

6) test cycles for sixteen (16) hours with an eight (8) hour rest/hold period. During the 8 hour rest/hold period no fill water is added, but the chamber stand still remains at 140° F. with a 15° F. deadband;

7) perform test runs for ten (10) days taking influent and effluent water samples at the beginning and end of the test for ICPMS analysis;

8) record gallons, element on time, and cycle count;

9) weigh heater elements prior to testing and at the end of the test to determine the mass of the element scale, collect free scale through sieve numbers 14, 20, and 40, and dry and weigh to determine total scale mass; and

10) thoroughly clean heat chambers before a new test is started, using new elements for each test.

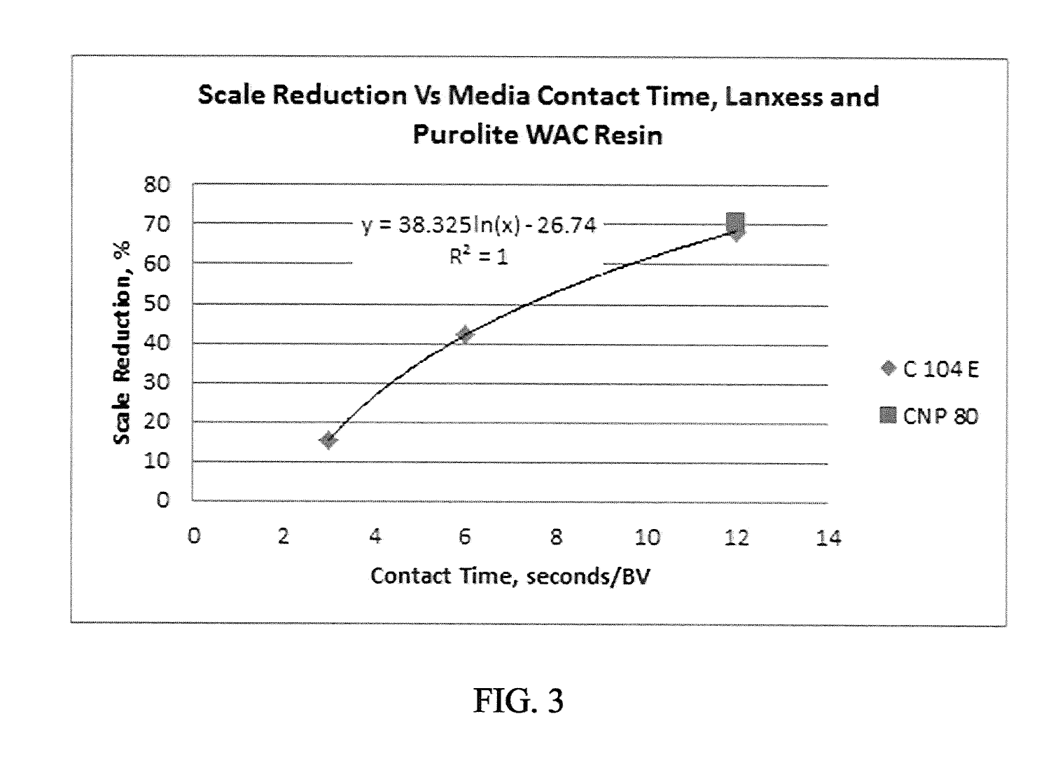

FIG. 3 depicts the scale reduction against media contact time for the Lanxess® and Purolite® WAC resins. The contact time is normalized to the bed volume measured as the volume of media, which in this test was 400 mL. As noted in FIG. 3, Lanxess® and Purolite® resins treated as described above resulted in a 60% to 65% mitigation of scale in a hot water heater test stand pursuant to the test procedure above to mimic the DVGW test used in Germany. Scale reduction increased relative to contact time per bed volume following the curve indicated in the figure. CNP 80 shown in FIG. 3 depicts the Lanxess® treated resin, while C 104E depicts the Purolite® treated resin.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A scale suppression media comprising polyacrylate resin beads combined with a monovalent strong acid salt directing agent to facilitate the formation of calcite and aragonite forms of calcium carbonate, said directing agent deposited directly into said polyacrylate resin beads.

2. The scale suppression media of claim 1 wherein said monovalent strong acid salt includes aluminum sulfate or zinc nitrate.

3. A method of preventing the formation of scale in fluid systems comprising: augmenting polyacrylate resin to release polymer from said resin beads into said fluid, precipitate calcium carbonate in pore structures of said polyacrylate resin beads, and template calcium ions into calcite or aragonite by doping said polyacrylate resin beads with a templating agent.

4. The method of claim 3 including dissolving said resin into said fluid and coating said calcium ions in said fluid.

5. The method of claim 3 including forming seed crystals of calcite or aragonite seeds by offering a template to steer calcium carbonate in solution.

6. The method of claim 3 wherein said templating agent includes calcium carbonate, aluminum, or zinc.

7. A method of producing a scale-control resin media comprising:
stabilizing said resin;
forming scale within said media to maximize the potential of condensing scale in said media's pore structure; and
generating scale templating agents.

8. The method of claim 7 wherein said step of stabilizing said resin includes:
neutralizing said resin to be free of calcium;
mixing said resin with sodium carbonate;
heating said mixture to approximately 80° C. for about four hours while stirring said mixture periodically;
rinsing said mixture with deionized water; and
drying said mixture at approximately 100° C. for about eight hours.

9. The method of claim 7 wherein said step of stabilizing said resin includes:
loading said resin with calcium without carbonate present;
mixing said resin with sodium carbonate;
heating said mixture to approximately 80° C. for about four hours while stirring said mixture periodically;
rinsing said mixture with deionized water;
combining said resin mixture with a solution of calcium chloride in deionized water;
heat said combination to approximately 80° C. while stirring said combination periodically; and
wash said heated combination with deionized water.

10. The method of claim 7 wherein said step of forming scale within said media to maximize the potential of condensing scale in said media's pore structure includes:
neutralizing acidity of said media by combining said resin with deionized water;
mixing said combined resin and water with sodium carbonate and calcium carbonate;
heating said mixture to approximately 80° C. while stirring periodically for about eight hours;
rinsing to remove excess calcium carbonate; and
drying said mixture at about 100° C. for approximately eight (8) hours.

11. The method of claim 7 wherein said step of generating scale templating agents includes loading said resin with calcium carbonate and a calcite directing agent or an aragonite directing agent.

12. The method of claim 11 wherein said calcite directing agent includes aluminum sulfate.

13. The method of claim 11 wherein said aragonite directing agent includes zinc nitrate or zinc chloride.

14. The method of claim 12 including:
mixing said resin with deionized water and adding aluminum sulfate;
heating said mixture at approximately 80° C. while stirring periodically for about four hours;
rinsing the heated mixture with deionized water and adding fresh deionized water;
adding calcium carbonate and calcium chloride;
heating the resultant mixture to about 80° C. with periodic stirring for about eight hours;
rinsing off excess carbonate with deionized water; and
drying the resultant product at about 100° C. for approximately eight hours.

15. The method of claim 13 including:
mixing the resin with deionized water;
dissolving the mixed resin in zinc nitrate or zinc chloride;
adding calcium carbonate and calcium chloride to said mixture;
heating the resultant mixture to approximately 80° C. with periodic stirring for about eight hours;
rinsing off excess carbonate with deionized water; and
drying the resultant product at about 100° C. for approximately eight hours.

16. A method of producing a scale-control resin media comprising:
treating a hydrogen form WAC resin by first neutralizing said resin with stoichiometric amounts of NaOH and passing it through said WAC resin in a column configuration to generate an Na form of the resin;
converting said Na form resin to a Ca form resin by passing an aqueous calcium solution through said Na form resin;
rinsing said aqueous calcium solution from said resin with deionized water; and
isolating said resin by dewatering through a filter.

17. The method of claim 16, wherein said stoichiometric amounts of NaOH includes using a 5% aqueous NaOH.

18. The method of claim 16 wherein said aqueous Ca solution comprises 100% stoichiometric Ca as a 10% aqueous solution.
